(19) United States
(12) Patent Application Publication
(10) Pub. No.: US 2011/0306525 A1
(43) Pub. Date: Dec. 15, 2011

(54) AQUEOUS DISPLACEMENT FLUID INJECTION FOR ENHANCING OIL RECOVERY FROM AN OIL BEARING FORMATION

(76) Inventor: Dirk Jacob Lighthelm, Volmerlaan (NL)

(21) Appl. No.: 13/201,402

(22) PCT Filed: Feb. 11, 2010
(86) PCT No.: PCT/EP2010/051678

§ 371 Date: Aug. 30, 2011

(30) Foreign Application Priority Data
Feb. 13, 2009 (EP) 09152822.4
Jun. 18, 2009 (EP) 09163151.5

(51) Int. Cl. C09K 8/588; C09K 8/58

(52) U.S. Cl. 507/225; 507/200; 507/219

(57) ABSTRACT

A method for enhancing recovery of crude oil from a porous subterranean formation of which the pore spaces contain crude oil and connate water comprises:—determining the Ionic Strength (Mol/l) of the connate water; and—injecting an aqueous displacement fluid having a lower Ionic Strength (Mol/l) than the connate water into the formation, which aqueous displacement fluid furthermore has an Ionic Strength below 0.15 Mol/l. FIGS. 13 and 16 and Table 4 demonstrate that injection of an aqueous displacement fluid with lower Ionic Strength than the connate water improves oil recovery (IOR).

### BACKGROUND OF THE INVENTION

The invention relates to a method for enhancing oil recovery (EOR) by injecting an aqueous displacement fluid into a porous subterranean formation of which the pore spaces comprise crude oil and connate water.

Such a method is known from International patent applications WO2008/029124 and WO2008/029131.

International patent application WO2008/029124 discloses that in a formation containing sandstone rock and minerals, such as clay, having a negative zeta potential the aqueous displacement fluid should have a total dissolved solids(TDS) content in the range of 200 to 10,000 ppm and the fraction of the total multivalent cation content of the aqueous displacement fluid to the total multivalent cation content of the connate water should be less than 1.

International patent application WO2008/029131 discloses the injection of an aqueous medium comprising a water soluble compound comprising at least one oxygen and/or nitrogen atoms, and wherein the fraction of the free divalent cation content of the medium to the free divalent cation content of the connate water in the formation is less than 1.

Other prior art references, which describe the interaction of salt and other chemicals in an aqueous displacement fluid with rock minerals and/or crude and hence are relevant for Enhanced Oil Recovery(EOR) processes are listed below:
1. Appelo, C. A. J. and Postma D., 1993, Geochemistry, Groundwater and Pollution, A. A. Balkema, Rotterdam/Brookfield.
2. Anderson, W. G., October 1986, Wettability Literature Survey—Part 1: Rock/Oil/Brine Interactions and the Effects of Core Handling on Wettability, J. of Petr. Techn., pp. 1125-1144.
3. Anderson, W. G., December 1987, Wettability Literature Survey—Part 6: The Effects of Wettability on Waterflooding, J. of Petr. Techn., pp. 1605-1622.
4. Austad, T., Strand, S., Hognesen, E. J. and Zhang, P., 2005, Seawater as IOR fluid in Fractured Chalk, Paper SPE 93000.
5. Austad, T., Seawater in Chalk: An EOR and Compaction Fluid, 2008, Paper ARMA 08-100, presented at the American Rock Mechanics Association, San Francisco, June 29-July 2.
6. Baviere, M., 1991, Basic Concepts in Enhanced Oil Recovery processes, Elsevier Applied Science, London.
7. Buckley, J. S., Takamura, K. and Morrow, N. R., August 1989, Influence of Electrical Surface Charges on the Wetting Properties of Crude Oils, SPE Reservoir Engineering, pp. 332-340.
8. Clementz, D. M., 1976, Interaction of Petroleum Heavy Ends with Montmorillonite, Clays and Clay Minerals, vol. 34, pp. 312-319.
9. Clementz, D. M., April 1982, Alteration of Rock Properties by Adsorption of Petroleum Heavy Ends: Implications of Enhanced Oil Recovery, SPE/DOE 10683, April 1982.
10. Craig, F. F. Jr., 1971, The Reservoir Engineering Aspects of Waterflooding, SPE Monograph Series, Volume 3, H. L. Doherty Series.
11. Dubey, S. T. and Doe, P. H., August 1993, Base number and Wetting Properties of Crude Oils, SPE Reservoir Engineering, pp. 195-200.
12. Dykstra, H. and Parsons, R. L., 1950, The Prediction of Oil Recovery by Water Flood, Chapter 12 from “Secondary Recovery of Oil in the United States”, pp. 160-74.
13. Hagoort, December 1974, J., Displacement Stability of Water Drives in Water-Wet, Connate Water-bearing reservoirs. Soc. Petr. Eng. J., pp. 63-71.
14. Jerauld, G. R., Lin, C. Y., Webb, K. J. and Seccombe, J. C., September 2006, Modeling Low-Salinity Waterflooding, SPE 102239, Paper presented at the 2006 SPE Annual Technical Conference and Exhibition, San Antonio, Tex., U.S.A., 24-27.
15. Lager, A., Webb, K. J., Black, C. J. J ., Singleton, M. and Sorbie, K. S., September 2006, Low Salinity Oil Recovery—An Experimental Investigation, SCA paper 2006-36, presented at the International Symposium of the Society of Core Analysts, Trondheim, Norway.
16. Lager, A., Webb, K. J. and Black, C. J. J., April 2007, Impact of Brine Chemistry on Oil Recovery, Paper A24 presented on 14^{th} European Symposium on Improved Oil Recovery—Cairo, Egypt.
17. Lager, A., Webb, K. J., Collins, I. R. and Richmond, D. M., 2008, LoSal™ Enhanced Oil Recovery: Evidence of Enhanced Oil Recovery at the Reservoir Scale, paper SPE 113976.
18. Looyestijn, W. J. and Hofman, J. P., Wettability-Index Determination by Nuclear Magnetic Resonance, April 2006 SPE Reservoir Evaluation and Engineering, pp. 146-153.
19. Maas, J. G., Wit, K. and Morrow, N. R., 2001, Enhanced Oil Recovery by Dilution of Injection Brine: Further Interpretation of Experimental Results. Paper SCA 2001-13.
20. McGuire, P. L., Chatman, J. R., Paskvan, F. K., Sommer, D. M. and Carini, F. H., 2005, Low Salinity Oil Recovery: An Exciting New EOR Opportunity for Alaska's North Slope, paper SPE 93903 presented at 2005 SPE Western Regional Meeting, Irvine, Calif.
21. Morrow, N. R. et al: “Prospects of Improved Oil Recovery Related to Wettability and Brine Composition”, paper presented at the 1996 International Symposium on Evaluation of Reservoir Wettability and Its Effect on Oil Recovery, Montpellier, France, 11-13 September.
22. Mysels, K. J., 1967, Introduction to Colloid Chemistry, Interscience Publishers, N.Y.
23. Pope, G. A., June 1980, The application of Fractional Flow Theory to Enhanced Oil Recovery, SPE 7660; also Society of Petroleum Engineers Journal, pp. 191-205.
24. Robertson, E. P., 2007, Low-Salinity Waterflooding To Improve Oil Recovery—Historical Field Evidence, SPE 109965.
25. Rueslatten, H. G., Hjelmeland, O. and Selle, O. M., 1994, Wettability of Reservoir Rocks and the influence of organo-metallic compounds, North Sea oil and gas reservoir, 3:317-324.
26. Shaw, D. J., 1966, Introduction to Colloid and Surface Chemistry, Butterworths, London.
27. Strand, S., Austad, T., Puntervold, T., Hognesen, E. J., Olsen, M. and Barstad, S. M. F., 2008, “Smart Water For Oil Recovery from Fractured Limestone: A Preliminary Study, Energy Fuels, 22(5), 3126-3133.
28. Stoll, W. M., Hofman, J. P., Ligthelm, D. J., Faber, M. J. and van den Hoek, P. J., June 2008, Towards Field-Scale Wettability Modification—The Limitations of Diffusive Transport, SPE Reservoir Evaluation & Engineering, pp. 633-640.
29. Tang, G. and Morrow, N. R., November 1997, Salinity, Temperature, Oil Composition and Oil Recovery by Waterflooding, SPE Reservoir Engineering, pp. 269-276.
30. Tang, G. and Morrow, N. R., 1999, Oil Recovery by Waterflooding and Imbibition—Invading Brine Cation Valency and Salinity, paper SCA-9911.
31. Tang, G. and Morrow, N. R., 1999, Influence of Brine Composition and Fines Migration on Crude Oil/Brine/Rock Interactions and Oil Recovery, J. of Petroleum Science and Engineering 24, 99-111.
32. Tang, G. and Morrow, N. R., 2002, Injection of Dilute Brine and Crude Oil/Brine/Rock Interactions, Environmental Mechanics: Water, Mass and Energy Transfer in the Biosphere, Geophysical Monograph 129, pp. 171-179.
33. Valocchi, A. J., Street, R. L. and Roberts, P. V., October 1981, Transport of Ion-Exchanging Solutes in Groundwater: Chromatographic Theory and Field Simulation, Water Resources Research, vol. 17, no. 5, pp. 1517-1527.
34. Van Olphen, H., 1963, An Introduction to Clay Coloid Chemistry, Interscience Publishers, John Wiley and Sons, New York.
35. Webb, K. J., Black, C. J. J. and Al-Ajeel, H., April 2003, Low Salinity Oil Recovery—Log-Inject-Log, paper SPE 81460 presented at SPE 13^{th} Middle East Oil Show & Conference, Bahrain 5-8 April.
36. Zhang, P., Tweheyo, M. T. and Austad, T., 2007, Wettability Alteration and Improved Oil Recovery by Spontaneous Imbibition of Seawater into Chalk: Impact of the potential determining ions Ca²⁺, Mg²⁺ and SO₄²⁻, Colloids and Surfaces. A. Physicochemical Eng. Aspects 301, 199-208.
37. Zhang, Y. and Morrow, N. R., 2006, Comparison of Secondary and Tertiary Recovery with Change in Injection Brine Composition for Crude Oil/Sandstone Combinations, SPE paper 99757.

The method according to the preamble of claim 1 is known from SPE paper 10995 “Low-Salinity Waterflooding To Improve Oil Recovery—Historical Field Evidence” presented by E. P. Robertson at the 2007 SPE Annual Conference and Exhibition in Anaheim, Calif., USA from 11 to 14 Nov. 2007. This prior art reference teaches that injection of a diluted formation water with a lower ionic strength than the connate water will improve oil recovery, but does not teach to which level the ionic strength should be reduced to have a significant improvement of oil recovery.

It is an object of the present invention to provide a further improved Enhanced Oil Recovery(EOR) method, wherein an aqueous displacement fluid is injected into a porous formation of which the pore spaces contain crude oil and connate water.

### SUMMARY OF THE INVENTION

In accordance with the invention there is provided a method for enhancing recovery of crude oil from a porous subterranean formation of which the pore spaces contain crude oil and connate water, the method comprising:
determining the ionic strength (Moles/Volume) of the connate water; and
injecting an aqueous displacement fluid having a lower ionic strength than the connate water into the formation and which aqueous displacement fluid has an Ionic Strength below 0.15 Mol/l.

Preferably the aqueous displacement fluid has an ionic strength below 0.1 Mol/l.

The formation may be a mineral-bearing sandstone or a carbonate formation and/or the method may further comprise:
determining a total level of multivalent cations (Moles/Volume) of the connate water; and injecting an aqueous displacement fluid having a lower total level of multivalent cations (Moles/Volume) than the connate water.

FIG. 16 demonstrates that injection of an aqueous displacement fluid of lower Ionic Strength (Moles/Volume) below 0.1 Mol/l than that of the connate water will yield improvement in oil production. It is shown that merely reducing the multivalent cation content from 0.22 Mol/l to zero Mol/l (table 4) will hardly yield additional oil production. It is the drastic lowering of Ionic Strength from about 4 Mol/l to 0.034 Mol/l (table 4) that will release the oil. It is anticipated that reduction of Ionic Strength to levels below around 0.1 Mol/l will be significantly improve oil production.

FIG. 13 demonstrates that the aqueous displacement fluid should be always lower in Ionic Strength (Moles/Volume) than the connate water and lower in total level of multivalent cations (Moles/Volume), where connate water of 2400 mg/l NaCl had an ionic strength of 0.04 Mol/l and zero multivalent cation level (Mol/l) (table 3, where the 24000 mg/l, 0.4 Mol/l case is shown) and the injected 24,000 mg/l CaCl₂ had an ionic strength of 0.6489 Mol/l (table 3) and 0.216 Mol/l multivalent cation level, leading to the adverse effect on oil production.

These and other features, embodiments and advantages of the method according to the invention are described in the accompanying claims, abstract and the following detailed description of non-limiting embodiments depicted in the accompanying drawings and tables, in which description reference numerals are used, which refer to corresponding reference numerals that are depicted in the drawings and tables.

### BRIEF DESCRIPTION OF THE TABLES AND DRAWINGS

Table 1 shows experimental data and undiluted brine compositions for Berea centrifuge experiments at 55° C.

Table 2 shows experimental data and undiluted brine compositions for Berea in-house experiments:

Dagang-like brine (after Ref. 32, Tang et al, 2002) and Berea and Brent Bravo oil properties.

Table 3 shows compositions of undiluted, pure NaCl, CaCl₂ and MgCl₂ brines in Berea experiments.

Table 4 shows experimental data and brines for experiments on Middle Eastern sandstone cores.

Table 5 shows Composition of brines, used in spontaneous imbibition experiments in Middle Eastern limestone core samples.

Table 6 shows an example of the composition of a formation brine.

In Tables 1-6 potentially important brine characteristics are indicated in bold.

FIG. 1 shows:
(a) a phenomenological definition of wettability; and
(b) the binding mechanism between clay and oil.

FIG. 2 shows decreasing oil relative permeability at increasing oil wetness.

FIG. 3 shows cartoons of bonding between clay surface and oil in a highly saline and low saline brine environment.

The Ca²⁺ ion represents the multivalent cations in the brine that act as bridge between clay and oil particles.

FIG. 4 shows the correlation between total salinity level TDS and divalent cation level (Ca²⁺+Mg²⁺) for formation waters of in-house reservoirs.

The grey data point indicates Brent seawater.

FIG. 5 shows the relationship between wettability index W and overall salinity level. The full lines depict various levels for oilwetting.

FIG. 6 shows the decreasing water fractional flow at decreasing salinity level.

FIG. 7 shows water saturation profiles for a highly saline water flood and a fresh water flood.

FIG. 8 shows a comparison of production profiles for a saline water flood and a Fresh Water Flood for 1-D flow. Dashed lines indicate water cut.

FIG. 9 shows a characteristic pressure profile during Fresh Water Flooding.

FIG. 10 shows imbibition capillary pressure curves from the centrifuge for Berea core plugs for undiluted and diluted brines at 55° C.

FIGS. 11A-C show result of an in-house experimental validation of the role of divalent cations on Berea at 60° C. NMR wettability determination indicates that change to mono-valent cations leads to reduction in adsorption of heavy hydrocarbons to rock minerals.

FIG. 12 shows a spontaneous imbibition experiment on Berea core material at ambient conditions.

Demonstration of resumed oil production upon switching to fresh water.

FIG. 13 shows a demonstration of suppression of oil production by injection of CaCl₂ brine on Berea core material under ambient conditions.

FIG. 14 shows a SEM picture of Middle East core sample. The contaminations on the pore walls are probably dispersed kaolinite particles.

FIG. 15 demonstrates resumed oil production at reduced differential pressure after switching to fresh water injection (ambient conditions).

FIG. 16 shows an experiment on Middle Eastern core material when using various injection brine compositions under ambient conditions, during 5 consecutive periods:
Period A: Formation water injection.
Period B: Injection of 240000 mg/l NaCl.
Period C: Injection of 2000 mg/l NaCl.
Period D: Injection of 2000 mg/l NaCl+10 mg/l Ca²⁺.
Period E: Injection of 2000 mg/l NaCl +100 mg/l Ca².

FIG. 17 shows results from spontaneous imbibition experiments on Middle Eastern limestone core material at 60° C.

FIG. 18 shows a possible fresh water effect in observed water cut reversal in production well in Middle East sandstone reservoir.

FIG. 19 shows a possible fresh water effect in oil production rate in production well in Middle Eastern sandstone reservoir.

FIG. 20 shows the dependence of intrinsic viscosity on brine ionic strength for various viscosifying polyacrylamide polymers with molecular weight M and a degree of hydrolysis.

FIG. 21 shows the viscosifying power of commercially available hyrolysed polyacrylamide in a formation brine with the composition shown in Table 6.

FIG. 22 shows an indication of the range of polymer concentration data and current estimate based on intrinsic viscosities for 90 mPa·s viscosity.

### DETAILED DESCRIPTION OF THE DEPICTED EMBODIMENTS

As brine composition profoundly influences reservoir wettability and hence microscopic sweep, careful design of injection brine is part of a strategy to improve on oil production in existing and future water flooding projects, in both sandstone and carbonate reservoirs and in combination with follow-up EOR projects.

In accordance with the present invention, the following results were found:
(1) Formation water with higher salinity level correlates to a higher content of multivalent cations. This causes the (sandstone) reservoir wettability to be more oilwet;
(2) The field-observed temporary reduction in water cut during breakthrough of injected fresh river water in a Middle Eastern sandstone reservoir with highly saline formation water was interpreted to be caused by an oil bank ahead of the fresh water slug;
(3) The oil bank results from improved sweep by wettability modification to more waterwet state. This interpretation was confirmed by laboratory experiments;
(4) Experiments in limestone core plugs demonstrate similar wettability modification, if the sulphate ion content in the invading brine is far in excess of the calcium ion content.

Based on these results the following conclusions were drawn:
(1) Fresh water injection may increase the Ultimate Recovery of oil by at least a few percent;
(2) There is scope for further improvement in oil production by flood front stabilization by adding low concentration polymer to the fresh water slug;
(3) If future EOR projects are planned, a preflush with fresh water is recommended to obtain more favourable oil desaturation profiles and savings on polymer costs;
(4) In case of seawater injection into fresh formation water reservoirs, removal of multivalent cations from the seawater should be considered to avoid the potential risk that the reservoir becomes more oilwet, which will result in reduced sweep.

The strategy of managing water composition can be extended to carbonate reservoirs.

The principal benefits of the method according to the invention are demonstrated in FIGS. 13 and 16 and Table 3.

FIG. 16 demonstrates that injection of an aqueous displacement fluid of lower Ionic Strength (Moles/Volume) below 0.1 Mol/l and lower than that of the connate water will yield improvement in oil production. It is shown that merely reducing the multivalent cation content from 0.22 Mol/l to zero Mol/l (table 4) will hardly yield additional oil production. It is the drastic lowering of Ionic Strength from about 4 Mol/l to 0.034 Mol/l (table 4) that will release the oil. It is anticipated that reduction of Ionic Strength to levels below around 0.1 Mol/l will be significantly improve oil production.

FIG. 13 demonstrates that the aqueous displacement fluid should be always lower in Ionic Strength (Moles/Volume) than the connate water and preferably lower in total level of multivalent cations (Moles/Volume), where connate water of 2400 mg/l NaCl had an ionic strength of 0.04 Mol/l and zero multivalent cation level (Mol/l) (table 3, where the 24000 mg/l, 0.4 Mol/l case is shown) and the injected 24,000 mg/l CaCl₂ brine had an ionic strength of 0.6489 Mol/l (table 3) and 0.216 Mol/l multivalent cation level, leading to the adverse effect on oil production.

In this description of the method according to the invention and in the accompanying claims, Tables, and Figures, the following abbreviations and nomenclature are used:
CEC Cation Exchange Capacity
E_{d} Displacement(Microscopic)Sweep efficiency
Eᵥₒₗ Volumetric Sweep Efficiency
I Ionic Strength (Mol/l), wherein

$$I = \frac{1}{2} \cdot {\sum }_{i} {C}_{i} \cdot {z}_{i}^{2} ,$$

with Cᵢ being molar concentration (Mol/l) and zᵢ being the valency of the specific ion and I summation over all anions and cations in the solution.
IFT InterFacial Tension (N/m)
M Water/oil Mobility Ratio
N Solution Normality (meq/l)
PV PoreVolume
SEM Scanning Electronic Microscope
S_{orw} True Residual Oil Saturation
S_{o,remain} Remaining Oil Saturation
TDS Total Dissolved Solids
W Wettability index: W=0 is waterwet; W=1 is oilwet.
WM brine Wettability Modifying brine

In the past decade, injection of brines with well-selected ionic composition in sandstone and carbonate reservoirs has been developed into an emerging Improved Oil Recovery (IOR) technology, aiming for improved microscopic sweep efficiency with reduction in remaining oil saturation as result (Ref. 29-31, Tang and Morrow, 1997, 1999, 2002; Ref. 19, Maas et al, 2001; Ref. 35, Webb et al, 2003 and Ref. 20, McGuire et al, 2005). Recently, some evidence of the beneficial impact of fresh water flooding from historical field data was published (Ref. 24, Robertson, 2007).

In-house research on this subject covered a broad range of disciplines, including core flow and Amott imbibition experiments, Colloid Chemistry and Petroleum Engineering. In the following detailed description of rock wettablity and oil recovery mechanisms results from a research study are provided and it is indicated where this technology can be most favorably applied.

FIG. 1 shows that wettability of reservoir rock can be phenomenologically defined as the fraction of the rock surface that is coated by adsorbed hydrocarbons.

A convenient parameter for characterisation is the wettability index W. For W=0, the porous medium is completely waterwet (zero hydrocarbon coating) and for W=1, the porous medium is completely oilwet (complete hydrocarbon coating).

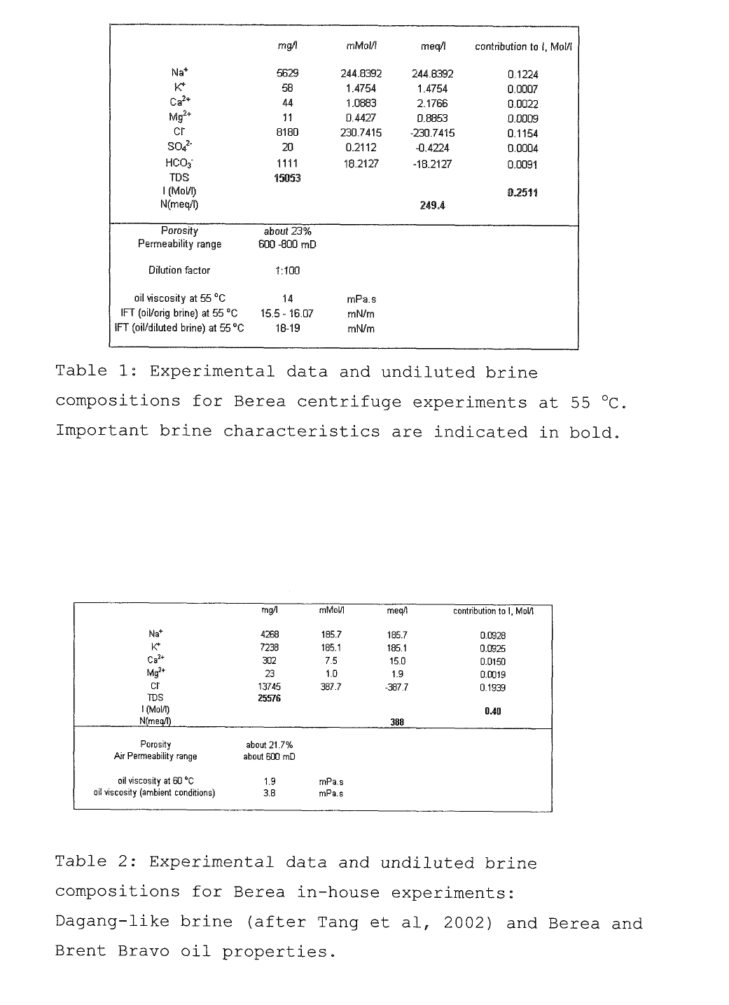

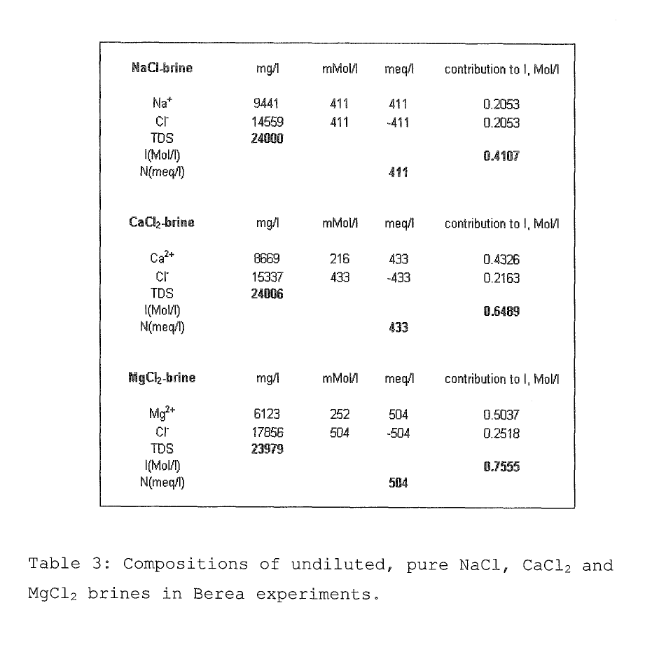

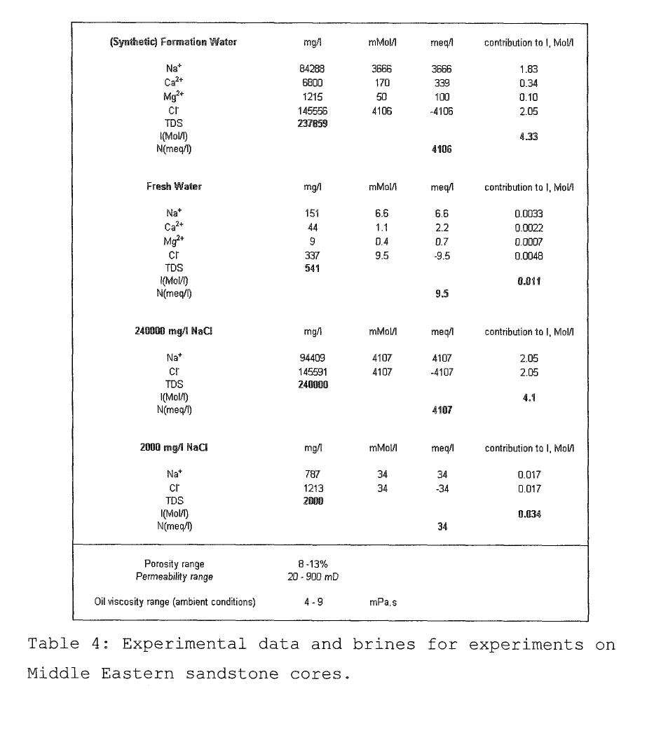

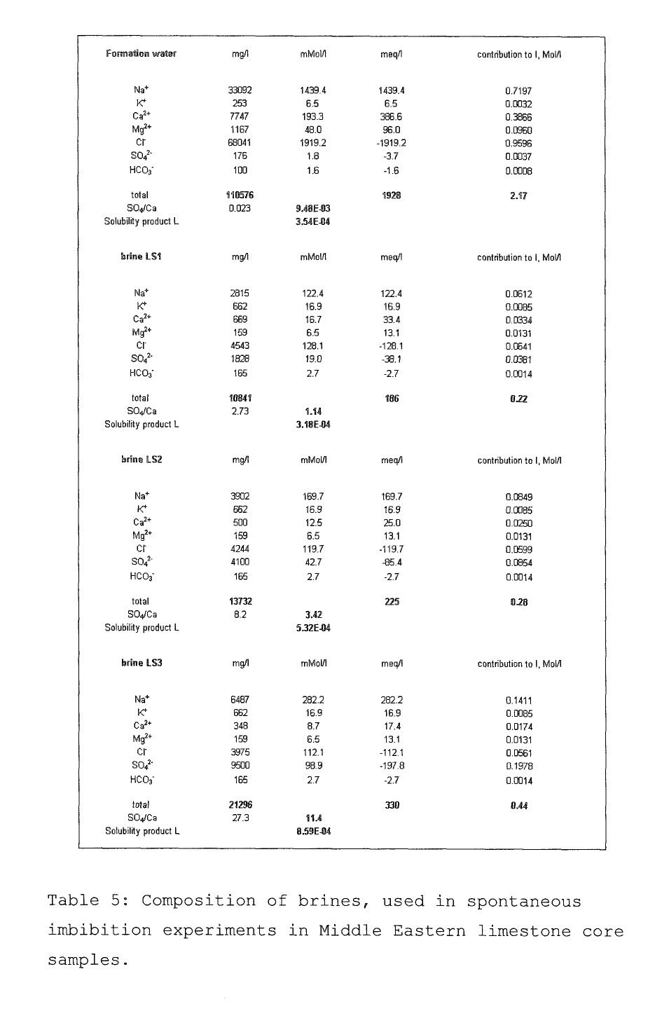

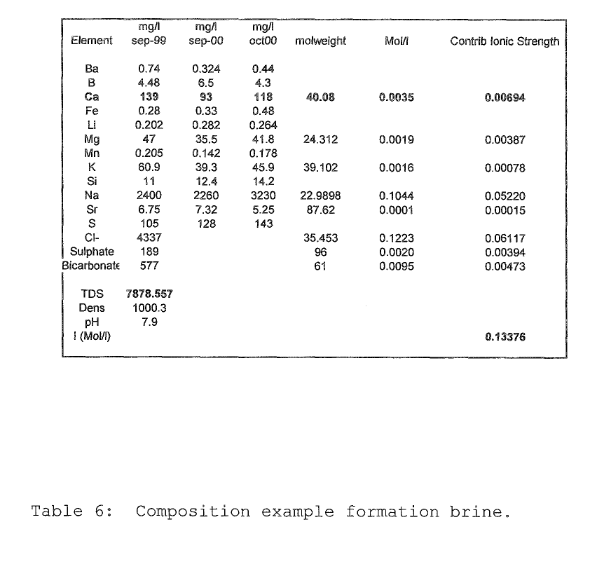

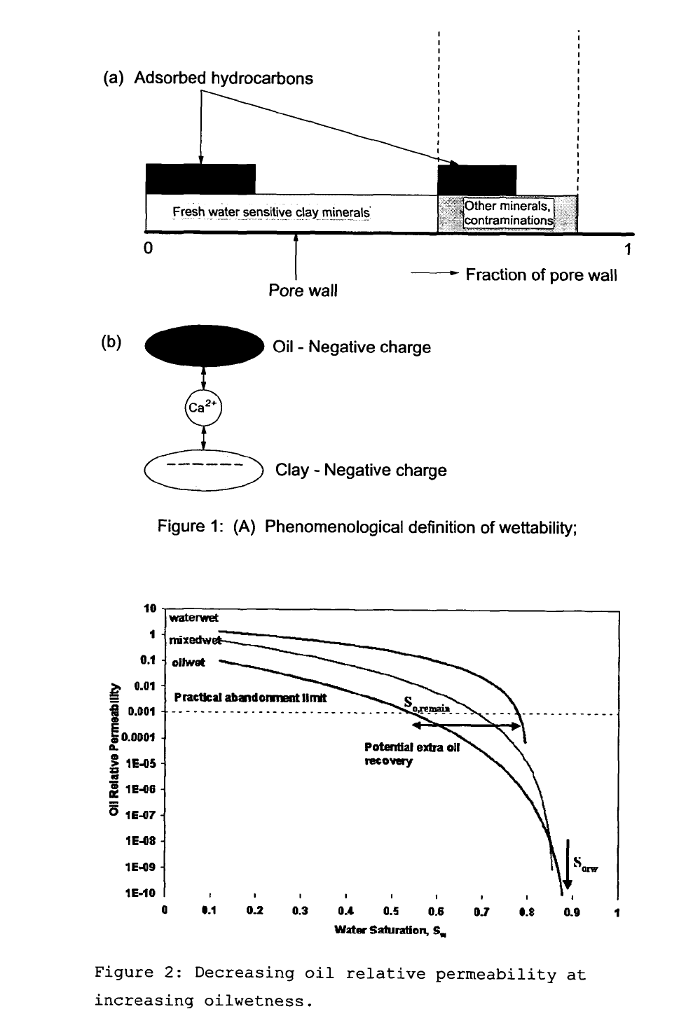

FIG. 2 shows that phenomenological correlations between wettability index W and relative permeabilities result in reduced oil relative permeability and increased water relative permeability at increase in oilwetness over a large saturation range. This shows that for increasing oilwetness, oil prefers to stick to the rock and to flow less easy, relative to water. The result is a less efficient microscopic sweep efficiency. Near the true residual oil saturation S_{orw} (which is the oil saturation level that cannot be further reduced irrespective of the applied differential pressure while avoiding desaturation by viscous stripping, (Ref. 3, Anderson, 1987)), there may be crossover of oil relative permeability curves. At increased oilwet state, there is increased oil film flow, being enabled by the continuous oil coating of the rock surface. This oil film flow allows for slow drainage of oil to low saturations (Ref. 2, Anderson, 1986). This process might be less effective in porous media with cleaner rock surface, which are more waterwet by definition.

The process of oil film flow is relevant if there is significant contribution to the oil recovery by oil-after-drainage in reservoir zones, invaded by injection water, as result of buoyancy forces. It is of less importance for waterflood processes, where the oil recovery is mainly the result from a normal lateral movement of the fluid front under diffuse flow conditions.

FIG. 2 shows that in that case, at field or well abandonment at say 95% watercut level, the oil relative permeability will have reached a low level of typically 1/1000- 1/100 and there will be left in the field a remaining oil saturation S_{o,remain}, that is well above the true residual oil saturation S_{orw} . Then, wettability modification towards more waterwet state may increase by several percent of PoreVolume (PV) the water saturation level that can be obtained by water flooding and similarly reduce the remaining oil saturation. By consequence, the ultimate amount of oil that can be produced prior to abandonment may increase by several percent of PV as well. The improvement in microscopic sweep efficiency can be assessed from fractional flow theory (Ref. 23, Pope, 1980; Ref. 14, Jerauld et al, 2006).

In the following section the relationship between Brine Chemistry and Wettability in Sandstone Reservoirs will be described.

In the pH range typically encountered in sandstone reservoirs both the silica surface (Ref. 2, Anderson, 1986) as well as the crude oil (Ref. 7, Buckley, 1989) bear negative electrical charge and one would expect no coating at all of silica rock by hydrocarbons, i.e. one would expect the silica to remain fully waterwet (Ref. 11, Dubey et al, 1993). However, usually there are contaminations, especially dispersed, electrically charged clay particles that line-up the porewalls. These particles are highly reactive and have a high specific surface area (Ref. 8, Clementz, 1976). Clay minerals behave as colloid particles, and in the pH range encountered in reservoirs they are often negatively charged due to imperfections in the crystal lattice (Ref. 34,Van Olphen, 1963; Ref. 1, Appelo, 1993). Multivalent metal cations in the brine such as Ca²⁺ and Mg²⁺ are believed to act like bridges between the negatively charged oil and clay minerals (Ref. 2, Anderson, 1986; Ref. 15&16, Lager et al, 2006, 2007).

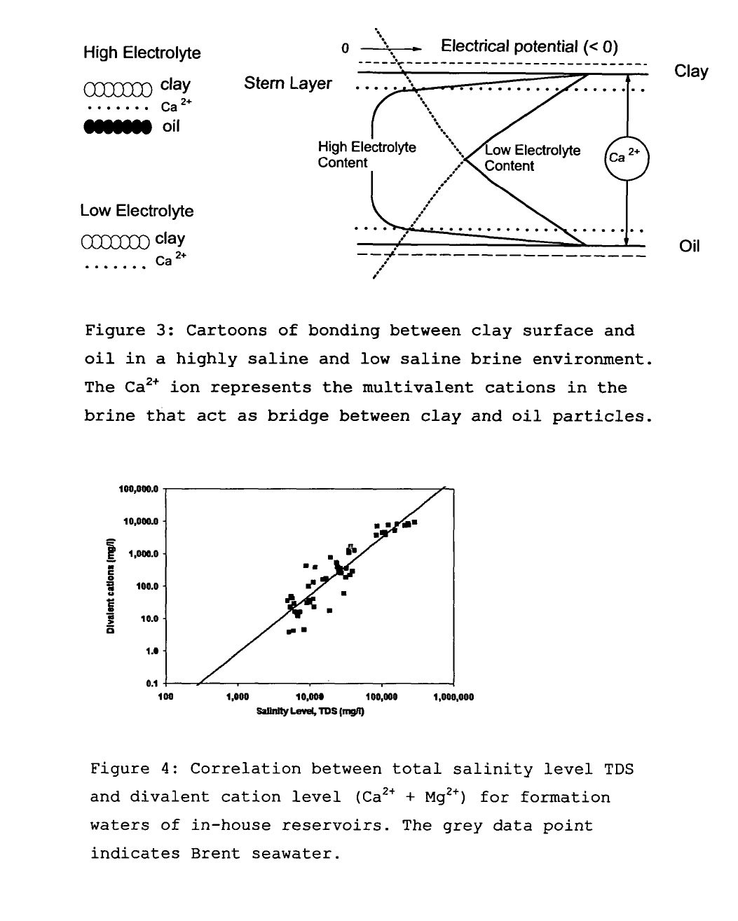

FIG. 3 shows that at a high salinity level, sufficient positive cations are available to screen-off the oil and the clay surface negative electrical charges with suppression of the electrostatic repulsive forces as result. This causes a low level of the negative electrical potential at the slipping plane between the charged surfaces and the brine solution (the so-called zeta potential). The zeta potential at the slipping plane is thought to be a good approximation of the (Stern) potential on the Stern layer. The Stern layer is defined as the space between the colloid wall and a distance equal to the ion radius, being free of electrical charge (Ref. 26, Shaw, 1966; Ref. 22, Mysels, 1967). In a sufficiently highly saline environment, oil can react with these clay particles to form organo-metallic complexes (Ref. 25, Rueslatten, 1994). This makes the clay surface extremely hydrophobic and causes local oilwetness (Ref. 9, Clementz, 1982).

FIG. 4 shows that, based on an analysis of in-house reservoir data, formation brines with a higher salinity level display a higher level of divalent/multivalent cations.

For a given crude with its specific oilwetting properties, characterized by acid number, base number and asphaltene content, formation brines with a higher salinity level, and by consequence with a higher level of multivalent cations, are expected to yield more oilwet states.

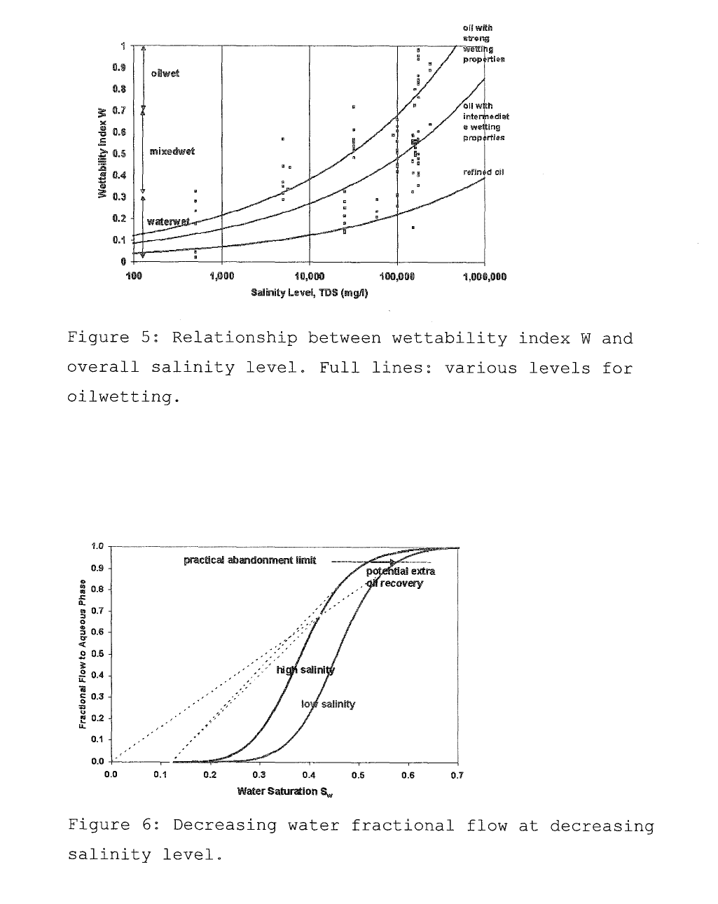

FIG. 5 shows how this is confirmed by in-house reservoir data.

In the following section the Mechanism of Wettability Modification by Fresh Water Flooding in Sandstone Reservoirs will be described.

Lowering of the electrolyte content (i.e. lowering of the Ionic Strength I=½·Σcᵢ·zᵢ² with cᵢ being the molar concentration of ion species i, zᵢ being its valency and with summation over all cations and anions in the brine) by lowering of the overall salinity level, and especially by reduction of the multivalent cations in the brine solution, reduces the screening potential of the cations. This yields expansion of the electrical diffuse double layers that surround the clay and oil particles and an increase in the absolute level of the zeta potential. FIG. 3 shows how this in turn yields increased electrostatic repulsion between the clay particle and the oil.

It is currently believed that once the repulsive forces exceed the multivalent cation bridge binding forces, the oil particles may be desorbed from the clay surfaces. This results in a reduction in the fraction of the rock surface that is coated by oil and, in turn, a change in wetting state towards increased water wetness. The above mechanism would especially occur at the interface between banked-up highly saline formation water and the invading Fresh Water Slug.

If the electrolyte concentration is reduced further, the mutually repulsive electrostatic forces within the clay minerals start to exceed binding forces, which leads to clay deflocculation and formation damage. Core flow experiments on Fresh Water Flooding by Zhang et al, 2006 et al were possibly carried out under conditions of formation damage, with increasing differential pressures over the core as result. This would modify wettability towards increased water wetness by stripping oil-bearing fine clay particles from the pore walls (Ref. 30, Tang and Morrow, 1999). Application of Fresh Water Flooding is recommended to remain restricted to salinity levels outside the region of formation damage where the adsorbed hydrocarbons are thought to be expelled from the clays but the clays remain intact.

In the following section cation Exchange Processes in Sandstone Reservoirs will be described.

In case of Fresh Water Flooding into a formation, the cation electrolyte content of the water will often be small compared to the Cation Exchange Capacity (CEC) of the formation. In that case, in the zone immediately behind the flood front between injection and formation water (the so-called salinity front), the cation composition of the injection brine is then determined by the cation composition on the clay minerals in the pore space. Based on the law of mass action, reduction in Na⁺ concentration by a factor α>1 in the brine behind the salinity front is accompanied by a reduction in divalent cation concentration (Ca²⁺, Mg²⁺) by a factor α² (Ref. 1, Appelo, 1993). This effect may cause the concentration of divalent cations in the zone behind the salinity front to be lower than in both the formation water and in the injection water. This stripping of divalent cations from injected low saline brine has been actually observed after breakthrough of the salinity front (Ref. 33, Valocchi, 1981; Ref. 17, Lager et al, 2008).

Reduction in multivalent cation content of a brine by stripping will lower the solution Ionic Strength and may contribute to double layer expansion and wettability modification. However, the cation stripping process is expected not to be essential to achieve wettability modification. Also, in the absence of any cation stripping, brine with a sufficiently low solution ionic strength is expected to be able to modify the wettability significantly. This was confirmed by a core flow experiment, to be described later.

In the following section the effects of High Salinity Flooding in Sandstone Reservoirs will be described.

It is speculated that injection of saline brine with a high level of multivalent cations, such as seawater, into the oil legs of an oil reservoir with low saline formation water (with a low level of multivalent cations), may change the wettability of such reservoir from rather water wet state to more oil wet state. This might be caused by chemical reactions at the flood front between oil and clay particles and the multivalent cations in the injection brine, with an increased level of hydrocarbon coating of the rock surface as result. This leads to more oilwet state and the eventual result might be increase in remaining oil saturation and reduced ultimate oil recovery in absence of an efficient water/oil gravity drainage process.

In the following section the relationship between Wettability and Oil Recovery in Carbonate Reservoirs will be described.

At pH below about 9.5, carbonate surfaces are positively charged (Ref. 2, Anderson, 1986; Ref. 1, Apello, 1993). Their clay content is usually sufficiently small to be ignored. At reservoir pH conditions, negatively charged oil particles will adsorb onto the positively charged carbonate rock surfaces by electrostatic attraction. Hence, the carbonates are expected to be mixed-to-oilwet.

As the carbonate is positively charged, it has anion exchange capacity and potential-determining anions such as SO₄²⁻ may adsorb to it. It is known that sulphate-containing fluids such as seawater can change the wettability of carbonates to more waterwet state (Ref. 4&5, Austad, 2005, 2008). A possible hypothesis on this mechanism has been described by Zhang et al (Ref. 36, 2007). In short, it is believed to be a result of sulphate adsorption in combination with excess calcium near the carbonate surfaces, which allows for substitution of adsorbed hydrocarbons by sulphate. At higher temperatures, magnesium may assist in this substitution process. It is a kind of anion exchange process.

It follows that the mechanism of wettability modification of carbonate surfaces is quite different from that of sandstones: there is no need for increased electrostatic repulsive forces by expansion of electrical double layers and hence there is no need for low electrolyte content.

In the following section the relationship between wettability and sweep efficiency in absence of water/oil gravity drainage will be described.

In Homogeneous Porous Media the displacement (microscopic) sweep efficiency will be as follows.

In absence of water/oil gravity drainage, an oil/water displacement process under diffuse flow conditions in a homogeneous porous medium can be described by fractional flow theory (Ref. 23, Pope, 1980; Ref. 14, Jerauld, 2006).

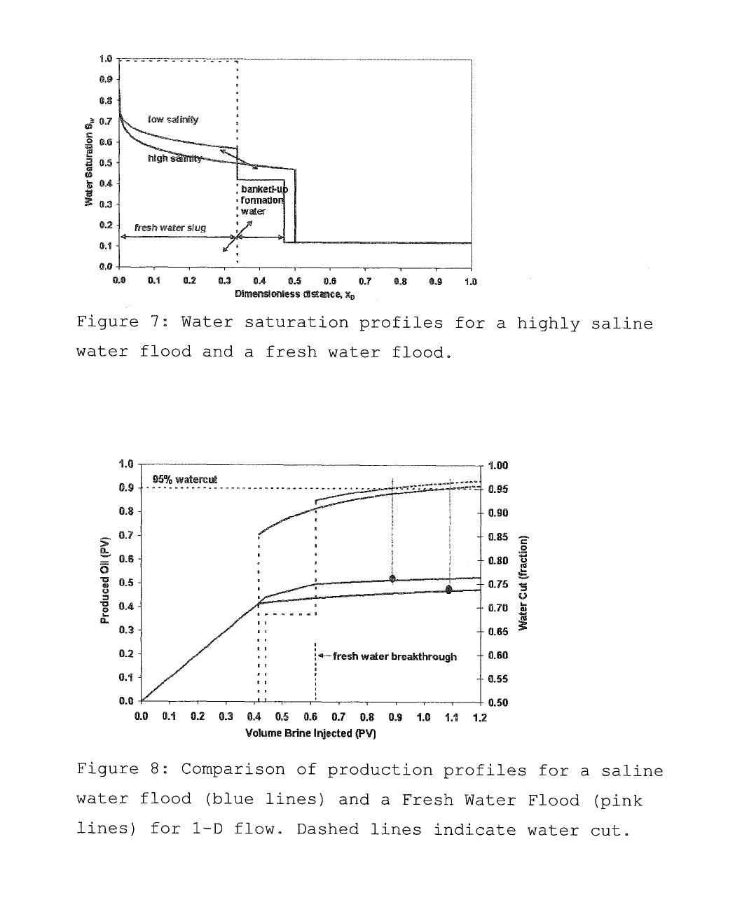

FIGS. 6-8 show a typical example for a mixed-wet formation. The example demonstrates the reduction in water fractional flow upon wettability modification by injection of a Wettability Modifying (WM)-brine, the displacement of formation water by the WM-brine slug, leading to a formation water bank ahead of the WM-slug and an increase in ultimate oil recovery, and hence in displacement (microscopic) sweep efficiency E_{d} at 95% water cut abandonment level. E_{d} is defined as the fraction of the oil saturation, which will be displaced from that portion of the reservoir that is contacted or swept by water. The wettability modification process is most efficient when applied from day one of a water flood, because then the amount of oil that may benefit from the improved sweep is at its maximum.

Full evaluation of the oil displacement process not only requires evaluation of saturation profiles but also of resulting phase pressure profiles. According to the shock front mobility ratio criterion (Ref. 13, Hagoort, 1974), there may be unstable displacement as result viscous fingering if the pressure gradient for a displacing fluid is lower than the pressure gradient for the fluid being displaced. Several examples show that WM-Floods may be unstable at the shock between the injection slug and the preceding banked-up formation brine because of a saturation effect.

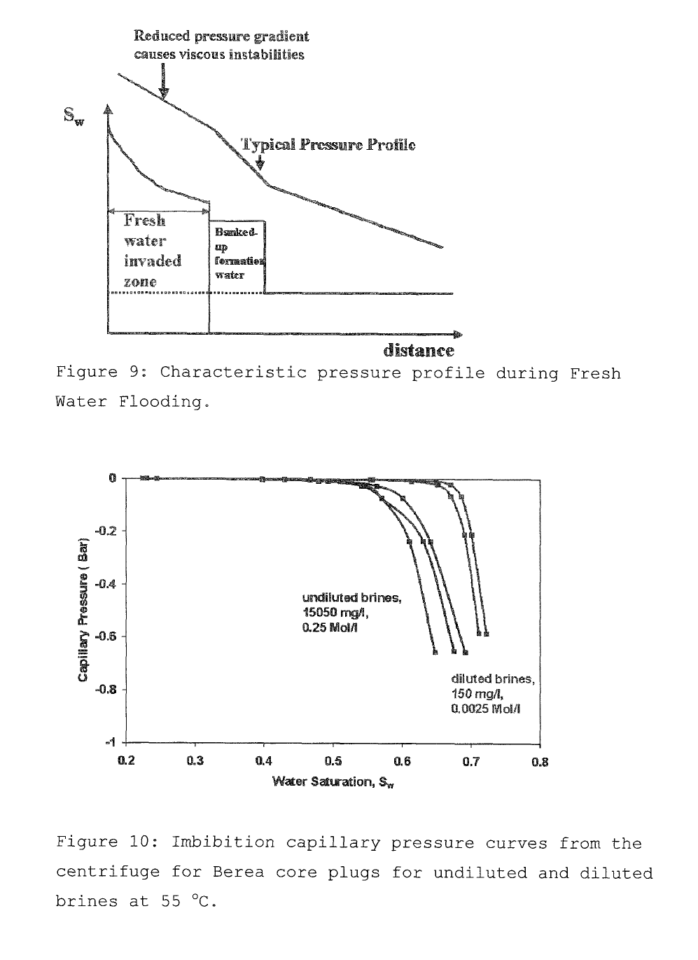

FIG. 9 shows that, due to the relatively high water saturation in the injectant-invaded zone (aiming for improved displacement sweep), the mobility of this slug may be higher than that of the preceding formation water bank, despite the reduction in water relative permeability by wettability modification.

The mobility of a fresh water slug is further increased because of somewhat reduced brine viscosity. Viscous instabilities may be avoided by making the WM-brine slug slightly more viscous by addition of some low concentration polymer. Especially in the case of fresh water flooding, the associated chemical costs might be relatively low when using a polymer such as hydrolyzed polyacrylamide, which is especially effective in low saline brine with respect to viscosity increase and reduction in adsorption.

In the following section the additional contribution of small-scale low permeability spots to displacement sweep efficiency will be described.

Within a layer a formation will display a wide variation in permeability levels, including low permeability spots which may largely remain bypassed during a highly saline water flood. If the formation is mixed-to-oilwet, there may be hardly any oil production from these bypassed spots by capillary-driven countercurrent imbibition. However, if these spots are of sufficiently small scale (e.g. a few cm), the WM-brine will be able to invade these spots by molecular diffusion (Ref. 28, Stoll et al, 2008). On the time-scale of molecular diffusion, which may be several years, these small-scale spots may produce additional oil by countercurrent imbibition as a result of wettability modification enabled by molecular diffusion and contribute to increase in displacement sweep.

In the following section the Volumetric Sweep Efficiency of the enhanced oil recovery methods will be described.

The assessment of the full potential benefits of application of Fresh Water Flooding in sandstone reservoirs requires assessment of not only the displacement sweep efficiency E_{d} but also of the volumetric sweep efficiency Eᵥₒₗ. Eᵥₒₗ is defined as the fraction of the reservoir volume that will be contacted by injected water. It is composed of the product of vertical sweep efficiency Eᵥₒₗ and areal sweep efficiency Eₐ. The single most important characteristic of a waterflood that determines Eᵥₒₗ is the water/oil mobility ratio M, which is defined in terms of the effective permeability and viscosity of the displacing and displaced fluids involved in the flood at two different and separated points in the reservoir, with the water relative permeability being evaluated at the average water saturation behind the displacement front (Craig, 1971). Available correlations from scaled laboratory experiments on pattern floods show that the areal sweep efficiency Eₐ decreases at increasing M. The linear stratified reservoir model without crossflow of Dykstra and Parsons (1950) shows that the vertical sweep efficiency Eᵥ similarly decreases at increasing M. Crossflow leads to further increase in this trend (Ref. 10, Craig 1971).

As explained before, WM-slugs may experience increased mobility. Apart from possible viscous instabilities mentioned before, this might also lead to some increase in mobility ratio M and by consequence to some loss in volumetric sweep efficiency. Therefore, adding some low concentration polymer to the WM-brine may be useful, not only to avoid viscous instabilities but also to compensate for some possible loss in volumetric sweep efficiency.

In the following section the synergy of a wettability-modifying preflush with EOR will be described.

It is believed that in an optimal design the make-up water for a polymer flood should honor WM-brine design criteria. Then the frontal part of the slug that has been depleted from its chemicals by adsorption could partially act as a wettability-modifying preflush. Subsequent Alkaline-Surfactant-Polymer slugs (in practice resulting in strongly reduced but still non-zero interfacial tensions) may benefit from possibly more favourable oil desaturation curves (Ref. 6, Baviere, 1991).

In the following section an Experimental Verification by In-House Laboratory Experiments will be described.

After careful wettability restoration by cleaning and ageing, two types of experiments on core samples were carried out to verify wettability modification towards a more waterwet state by invasion of WM-brine:
1. Amott spontaneous imbibition experiments. The core, being cleaned and aged with crude oil and formation brine (Ref. 2, Anderson, 1986), is put in a glass tube and surrounded by the same formation brine. Oil production occurs by spontaneous imbibition until capillary equilibrium has been reached. Subsequently, the surrounding formation brine is replaced by WM-brine. Resume of oil production demonstrates the occurrence of a positive capillary pressure within the core. This is only possible if the brine composition within the core has changed because of molecular diffusion and has caused a reduction in the amount of adsorbed hydrocarbons on the rock surface.
2. Low rate core flood experiments. The WM-brines which are used in the experiments are sufficiently high in salinity level to avoid formation damage. Formation damage can be observed from a gradual increase in differential pressure during a core flow experiment and should be avoided to prevent unnecessary complications as a result of the so-called capillary end effect in the interpretation of the experiments. The typical result from a core flow experiment would be as follows: At the end of the injection period of Formation Water, a stationary situation is established in which oil production has ceased and the differential water phase pressure is at a stable level. In this situation the water saturation distribution in the core is such that—apart from a small buoyancy force in a vertically oriented core—the negative capillary pressure over the core is exactly in balance with the water phase pressure, which results from the stationary viscous pressure drop due to the water flow. After switching to WM-Brine, oil production may resume at the same or at even a somewhat lower differential water phase pressure over the core. This is only possible if the capillary pressure level over the core is reduced. Then the water saturation in the core will increase (with as a consequence some oil production) until the capillary pressure level over the core has increased to balance the water phase pressure again. Due to the oil production, the water phase mobility in the core has increased, leading to some additional drop in differential pressure over the core. Additional oil production in itself after the switch to WM-brine injection does not uniquely prove that wettability modification towards a more waterwet state has occurred. Reduction in oil/water interfacial tension would yield similar observations. The above makes clear that additional measurement of oil/water interfacial tensions for high and low saline brines is mandatory to arrive at proper interpretation of the experimental results. Follow-up in-house laboratory work has showed that within the experimental error no evidence could be obtained on the dependence of water/oil interfacial tension on salinity level. If one would nevertheless try to discover some trend, at least for our systems studied, the interfacial tension tends to increase rather than to decrease upon dilution. Also fluid viscosity and density measurements, NMR wettability determination and in situ saturation profiles and numerical simulations are required to draw more refined conclusions, e.g. on possible changes in relative permeability curves, which are indicative for wettability modification and relevant for improved oil production on reservoir scale.

It follows that conclusions from core flow experiments are always drawn with help of simulation models and some inevitable assumptions, whereas error bars in the experimental results will tend to make conclusions less firm. Therefore, to obtain firm evidence for wettability modification, core floods were accompanied by Amott spontaneous imbibition tests. Despite the difficulties mentioned, core flow experiments (including monitoring of profiles of differential pressure and insitu saturation) are essential to obtain information on relative permeability curves before and after the wettability modification, which in turn is essential to obtain an estimate of its potential benefits on field-scale.

FIG. 10 shows a series of imbibition capillary pressure curves obtained by laboratory experiments with Berea sandstone core plugs, which were measured with the centrifuge at 55° C. The oil used was CS crude, obtained from the University of Wyoming (Ref. 32, Tang et al, 2002). In these experiments, the brine compositions for ageing and oil displacement were chosen identical.

Table 1 provides a list the obtained experimental data. These data clearly show that the experiments with the diluted brines at 100 times lower Ionic Strength I=0.0025 Mol/l yield capillary pressure curves, which are representative for a relatively more waterwet state than those with the undiluted brines with I=0.25 Mol/l.

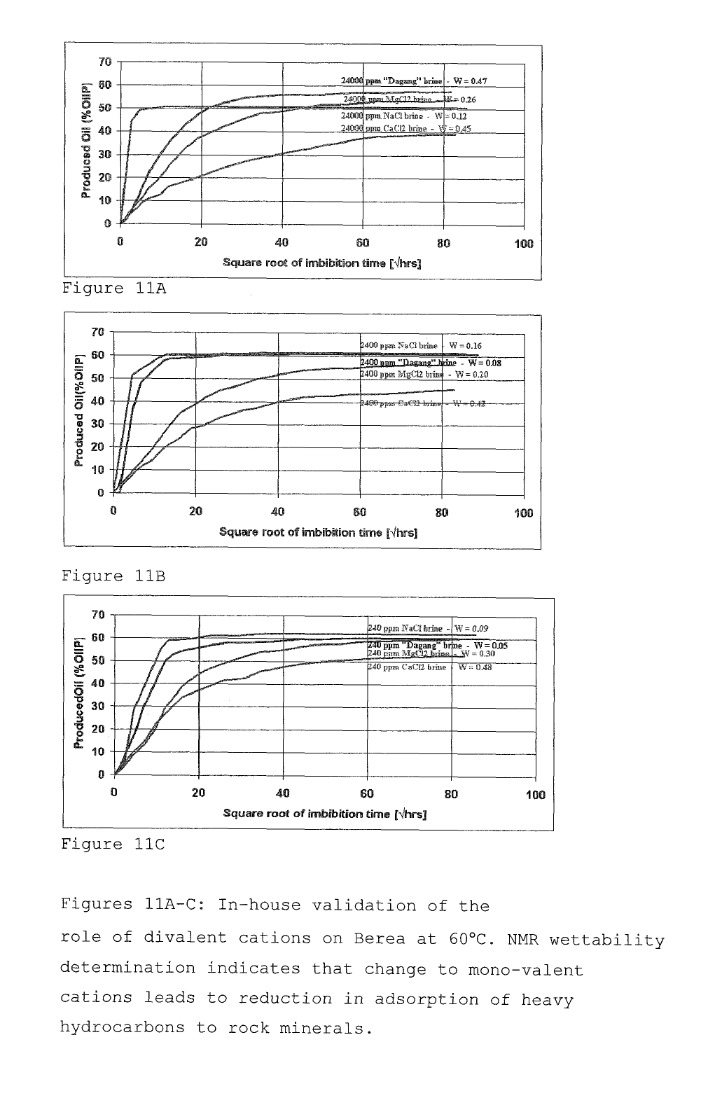

FIG. 11 shows the results of a series of spontaneous Amott imbibition tests at 60° C. for Berea sandstone core plugs. Also in these tests, the brine compositions for ageing and oil displacement by brine invasion were chosen identical. The oil used was Brent Bravo crude and one of the undiluted brine compositions was based on that of Dagang brine (Ref. 32, Tang et al, 2002), which consists of mainly Na⁺ and K⁺ with addition of some Ca²⁺ and Mg²⁺. Pure NaCl, CaCl₂ and MgCl₂ brines were tested as well.

Tables 2 and 3 provide lists of the experimental details and the undiluted brine compositions are listed.

The trend found is that spontaneous imbibition for the pure MgCl₂ and especially the pure CaCl₂ brines is less efficient than for the pure NaCl and Dagang brines. Hence the experimental results suggest that multivalent cations in the brines make reservoir rock less waterwet. This finding is supported by determination of the NMR wettability index (Ref. 18, Looyestijn, 2006), which indicates that change to monovalent cations leads to reduction in adsorption of heavy hydrocarbons to rock minerals. Similar results have been reported by Morrow et al (Ref. 21, 1996). In addition to these experiments it was verified that Berea samples, aged and brought into capillary equilibrium with 24000, 2400 and 240 mg/l pure NaCl brine, did not show any resume of oil production when the pure NaCl brines were replaced by 100 times diluted Dagang brine. This confirms that pure NaCl brines keep the samples in waterwet state. This finding is in agreement with results reported by Lager et al (Ref. 15, 2006).

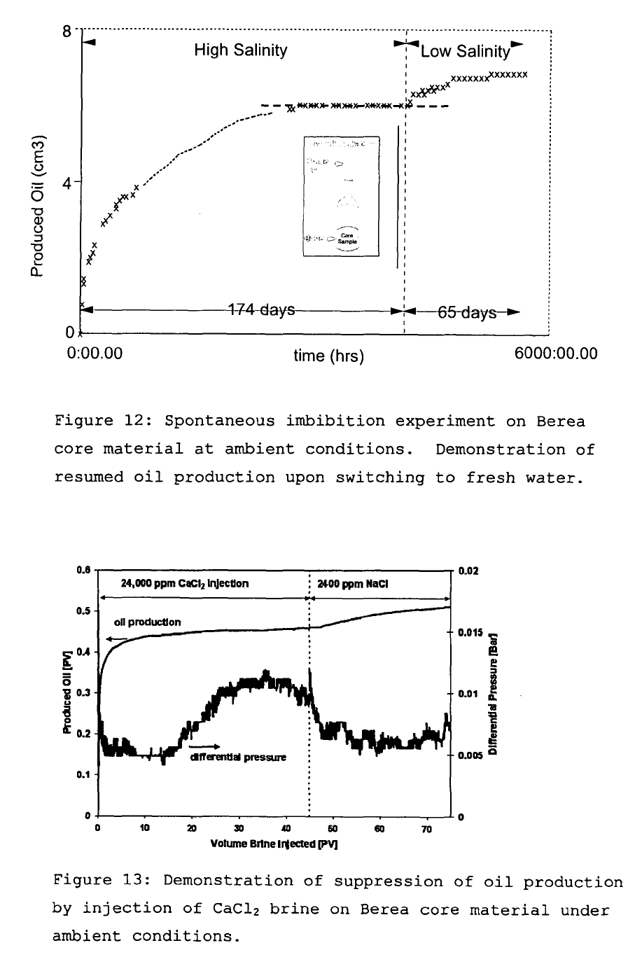

FIG. 12 shows that, in an Amott spontaneous imbibition experiment at ambient conditions for a Berea sandstone core plug aged with undiluted Dagang brine as connate water and Brent Bravo crude,—once oil production has ceased after imbibition of undiluted Dagang brine—oil production resumes after switching to 100-fold diluted Dagang brine as invading brine. This demonstrates that fresh brine invasion makes the core material more waterwet.

FIG. 13 shows the results of a low rate core flow experiment at 0.32 m/day under ambient conditions that was carried out to test the hypothesis that High Salinity Flooding might make reservoir rock more oilwet and jeopardize sweep. The experiment was conducted by:
(1) Ageing of Berea core material with Brent Bravo crude and 2400 mg/l NaCl;
(2) Injecting 45 PV of 24000 mg/l CaCl₂ brine until oil production has ceased and pressure has stabilized;
(3) Continuing injection of 2400 mg/l NaCl brine.
   In this experiment it was observed that after injection of about 15 PV of CaCl₂ brine, when the stationary state has more or less been reached, the water phase differential pressure gradually started to increase.

As it was verified that this CaCl₂ brine does not yield formation damage, the increasing water phase differential pressure suggests redistribution of water and oil over the sample and especially reduction in water saturation and hence water relative permeability at the outflow face of the core. This would imply that the core becomes gradually more oilwet. After switching to 2400 mg/l NaCl brine, there is resumed oil production at gradually decreasing water phase differential pressure (partly as a result of a reduction in brine viscosity). This suggests that there has been suppression of oil production during injection of the CaCl₂ brine. If the core indeed has become gradually more oilwet during the injection of 45 PV of CaCl₂ brine, this suppression of oil production has taken place gradually during the CaCl₂ brine injection, i.e. the produced oil during the first PVs of CaCl₂ injection will probably have been produced under more or less initial wetting state conditions, but gradually the wetting state has changed towards increased oilwetness and the oil production was more and more suppressed. The ability of CaCl₂ brine to create less waterwet state is consistent with the results from the Amott imbibition experiments shown in FIG. 11 and consistent with results by Tang et.al (Ref. 29, 1997) and McGuire et al (Ref. 20, 2005).

In the following section experiments with Middle Eastern Sandstones will be described.

Table 4 indicates that Amott imbibition cell experiments on Middle Eastern core samples at ambient conditions show no spontaneous imbibition of highly saline formation water at all at nevertheless a low level of initial water saturation. This indicates that the sample is rather oilwet.

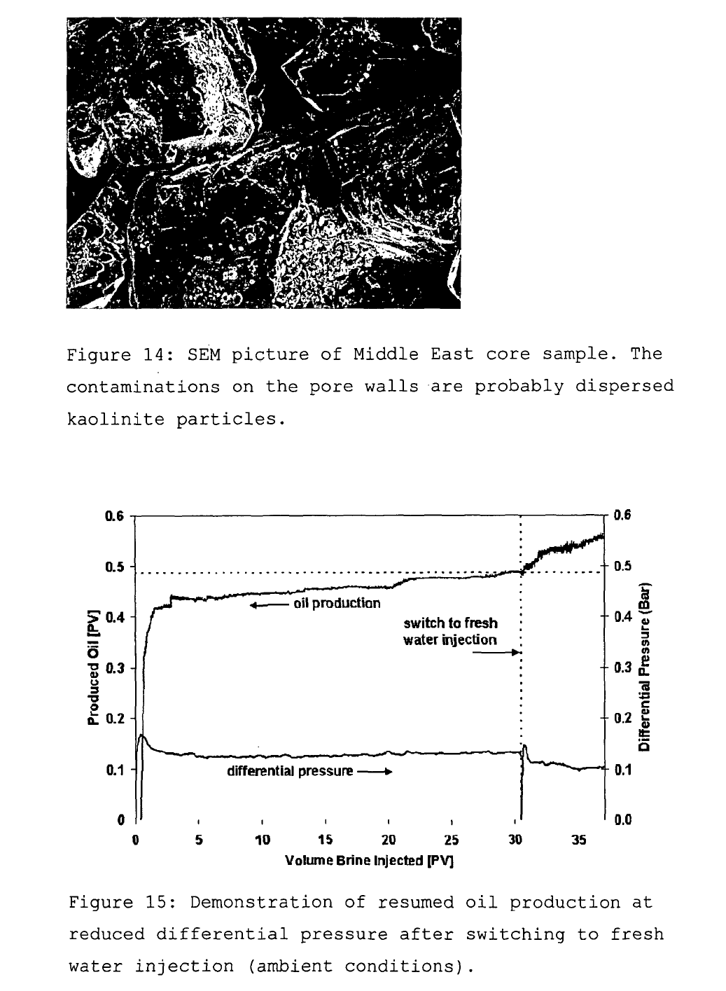

FIG. 14 shows pictures from a Scanning Electronic Microscope(SEM) which illustrate that the clay is dispersed as fines over the whole pore space, although the clay content of the sample is low by only a few percent kaolinite of rock bulk weight.

This may explain its ability to let adsorbed hydrocarbons cover a large part of the rock surface.

Table 4 shows that, after changing the invading formation brine to fresh water, oil production slowly sets on, with an ultimate oil recovery of 24 PV %. This shows the ability of fresh water to change wettability of the core to more waterwet state.

FIG. 15 shows the ability of fresh water to change wettability to more waterwet state is also recognized in the low rate core flow experiment at ambient conditions at 0.32 M/day. After switching to fresh water injection, oil production resumes at lower differential pressure over the core because of reduction in brine viscosity. This points into the direction of reduced level of (negative) imbibition capillary pressure. As there is no evidence of reduction in oil/brine interfacial tension when switching from formation brine to fresh water, the reduction in capillary pressure must be attributed to wettability modification to more waterwet state. This conclusion is consistent with the result from the Amott tests.

Detailed analysis of the experimental results, in combination with the available SCAL correlations has led to the conclusion that the wettability changes from rather oilwet to mixedwet upon injection of fresh brine. Upscaling of the experimental results to reservoir scale using fractional flow theory indicates that the amount of produced oil by improvement in displacement efficiency may possibly increase by about ten percent.

It was described before from theoretical arguments that the mechanism of wettability modification by Fresh Water Flooding relies on expansion of the electrical double layers. The following core flow experiment on rather oilwet Middle Eastern core material supports this picture.

Table 4 provides the experimental data of this core flow experiment.

FIG. 16 shows the results thereof on production. The following experimental stages A-E were applied:
A) Period A: Injection of over 50 Pore Volumes of formation water of about 238000 mg/l TDS with 84300 mg/l Na⁺, 6800 mg/l Ca²⁺ and 1215 mg/l Mg²⁺ until a stationary state of no oil production any more is reached. During this stage, a certain fraction of the clay particles is expected to become occupied by Ca²⁺ and Mg²⁺.
B) Period B: Injection of about 30 Pore Volumes of 240000 mg/l pure NaCl brine, that is free from any multivalent cations and has a similar ionic strength as the formation water. In view of the low Cation Exchange Capacity of the rock (7.3 meq/l porespace) and the relatively high cation content or solution normality N of the NaCl brine (4107 meq/l ), we expect that at the end of this injection period a new chemical equilibrium has been established, where all Ca²⁺ and Mg²⁺ have been flushed from the clays and have been replaced by Na⁺. One would expect that hydrocarbons being adsorbed to the clays by pure cation binding be removed, with wettability modification towards increased waterwet state as result. This is confirmed by the experimental results: there is indeed resumed oil production at about the same level of differential pressure over the core, but it is a rather small amount. This shows that merely flushing of the multivalent cations from the exchanger without double layer expansion by significant reduction in ionic strength is not sufficient to significantly change the wettability to more waterwet state and obtain significantly improved oil production. This is consistent with the results from Webb. et al (Ref. 35, 2003).
C) Period C: Injection of 2000 mg/l pure NaCl brine, that is free from any multivalent cations and has hundred-fold reduction in ionic strength. As both the clays and the solution now only contain Na⁺, no cation exchange or stripping effects are expected to occur. Nevertheless, a significant increase in oil production rate is observed at an even lower level of differential pressure, indicating further removal of adsorbed hydrocarbons from the clays and change to more waterwet state. The only mechanism left to achieve this is by increased repulsive electrostatic forces due to double layer expansion. The low saline brine injection continues until a stationary state of no any more oil production is reached.
D) Period D: Injection of 2000 mg/l NaCl brine, containing 10 mg/l Ca²⁺. As Ca²⁺ is expected to reduce the double layer expansion (Schulze-Hardy rule) and to promote adsorption of hydrocarbons to clays, during this stage no significant increase in oil production rate is expected. This is confirmed by the experiment.
E) Period E: Injection of 2000 mg/l NaCl brine, containing 100 mg/l Ca²⁺ does not yield increase in oil production rate for the same reasons as outlined for period D.

The major conclusion from this experiment is that cation exchange processes may be partly responsible for wettability modification to increased waterwetness (Period B). However, the major contribution to such wettability modification would come from sufficient reduction in brine ionic strength (Period C). The results from Period B and C suggest that also in the absence of cation exchange processes, brine with a sufficiently low solution ionic strength is able to modify the wettability significantly.

In the following section results of experiments with core Samples containing Smectite or Chlorite Clays will be described.

Core flow experiments with Fresh Water Brine on core material, being abundant in the clay mineral smectite, show some benefits from fresh water injection, but also suffer from a gradually increasing differential pressure over the core as a result of formation damage. As fresh water injection must be applied outside the rang of formation damage, in these type of formations fresh water injection is probably limited to such high salinity levels, that the benefits for the oil production may be rather moderate.

Zhang et al (2006) have shown that the abundancy of fresh-water insensitive chlorite clay minerals may possibly reduce the effectiveness of fresh water flooding.

In the following section results of experiments with Middle Eastern Limestones will be described.

Although the mechanism of wettability modification by anion exchange processes has been well established for chalk material, we are not entirely sure that what works for chalk is identically applicable to microcrystalline limestone, such as found in the Middle East. Indeed, the first results by Strand et al (Ref. 27, 2008) on Middle Eastern limestone core material suggest that the process may work for Middle East limestones as well.

For further validation, a number of spontaneous imbibition tests were carried out at 60° C. on Middle Eastern Limestone core samples of about 3 mD permeability and about 29% porosity. The oil viscosity was 4.4 mPas. Table 5 shows the brine properties, including the overall salinity level in mg/l TDS, ionic strength in Mol/l, solution normality in meq/l and solubility product.

The formation brine is based on the composition taken from a representative Middle Eastern limestone reservoir and the wettability modifying brine LS1 is representative for water taken from a fresh aquifer water well. Brines LS2 and LS3 are modifications from LS1 by increasing the sulphate content and reducing the calcium content, to avoid exceeding the critical solubility constant and precipitation of calcium sulphate.

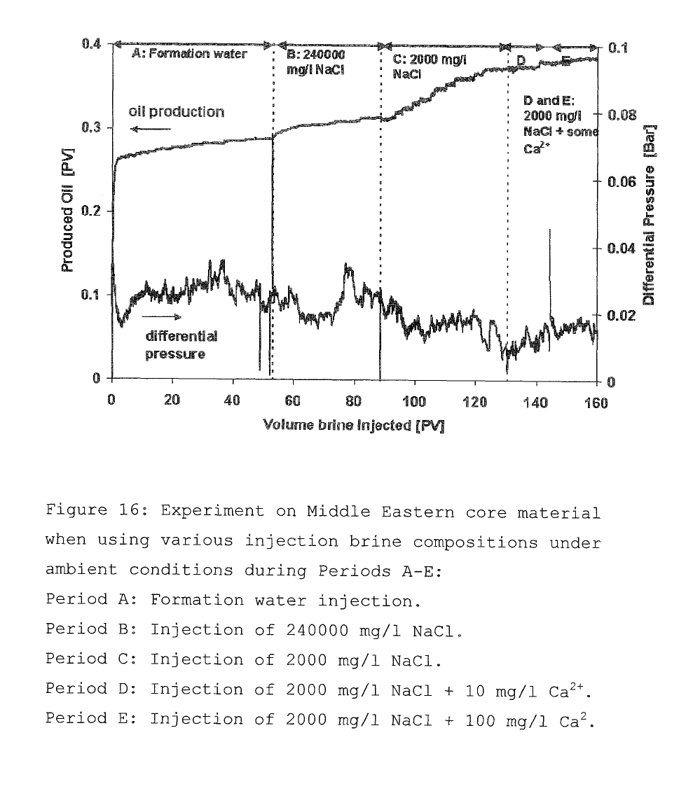

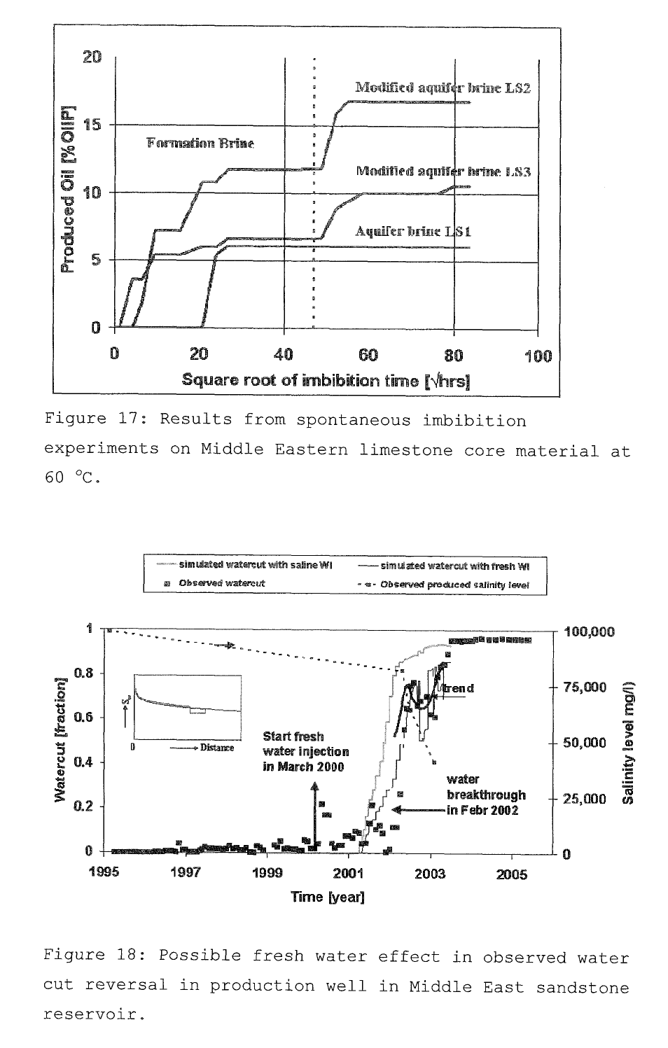

After finalizing spontaneous imbibition by formation water, one core sample was surrounded by brine LS1, the second one by brine LS2 and the third one by brine LS3. FIG. 17 shows the results of these experiments and that Brines LS2 and LS3 yielded a response, indicating wettability modification towards increased waterwet state. The absence of a response for brine LS1 is attributed to a still to low value for the sulphate to calcium ratio. The pH varied between 6.6 and 7.8.

Inspection at a later stage of the mixing properties of the formation brines with the wettability modifying brines in mixing ratio 1:1 revealed that some precipitation of CaSO₄ and CaCO₃ did occur. It follows that in future experimental work, brines will be verified for the absence of precipitation as this will reduce the calcium and sulphate content of the wettability modifying brine. This in turn would reduce its wettability modifying power.

In the following section results of field observations on Fresh Water Flooding in Middle East Sandstone Reservoir will be described.

A fresh water effect has (possibly) been observed in an oil production well in a Middle Eastern sandstone reservoir. The formation wettability is thought to be in-between mixed-wet and oil-wet. The field contains light oil of 0.15 mPa·s viscosity. Oil is produced from an aquifer drive. However, since March 2000 additional support is obtained from fresh water injection in an injector well. The salinity of the aquifer water is typically 100000 mg/l TDS and the salinity of the fresh water is around 1000 mg/l TDS.

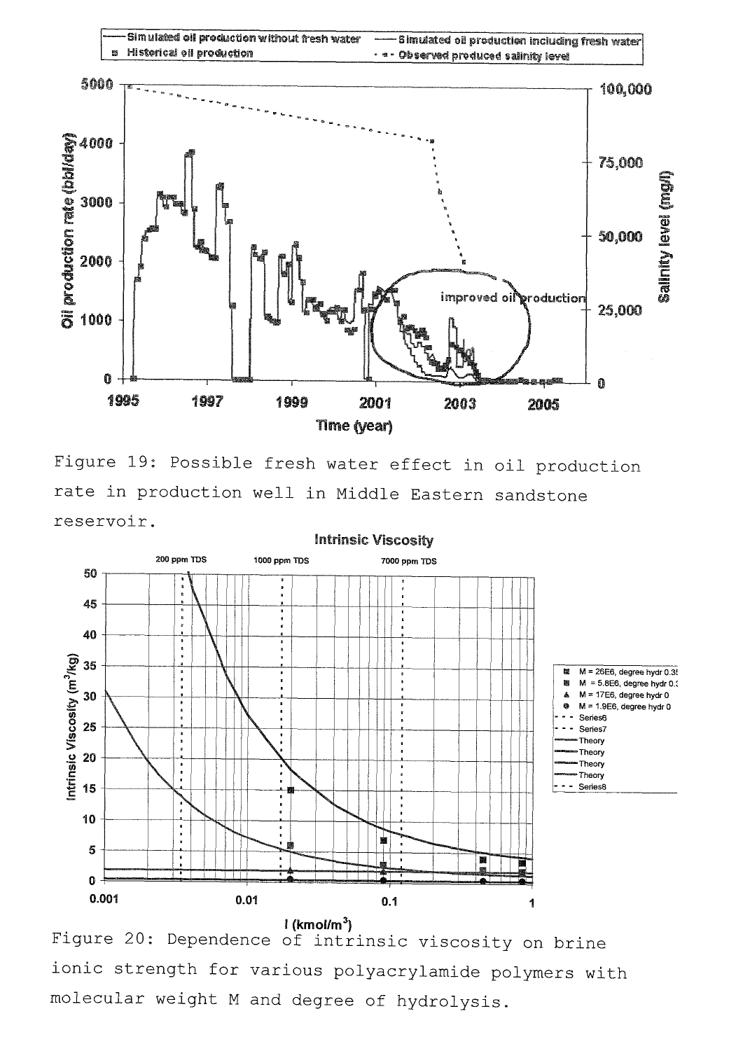

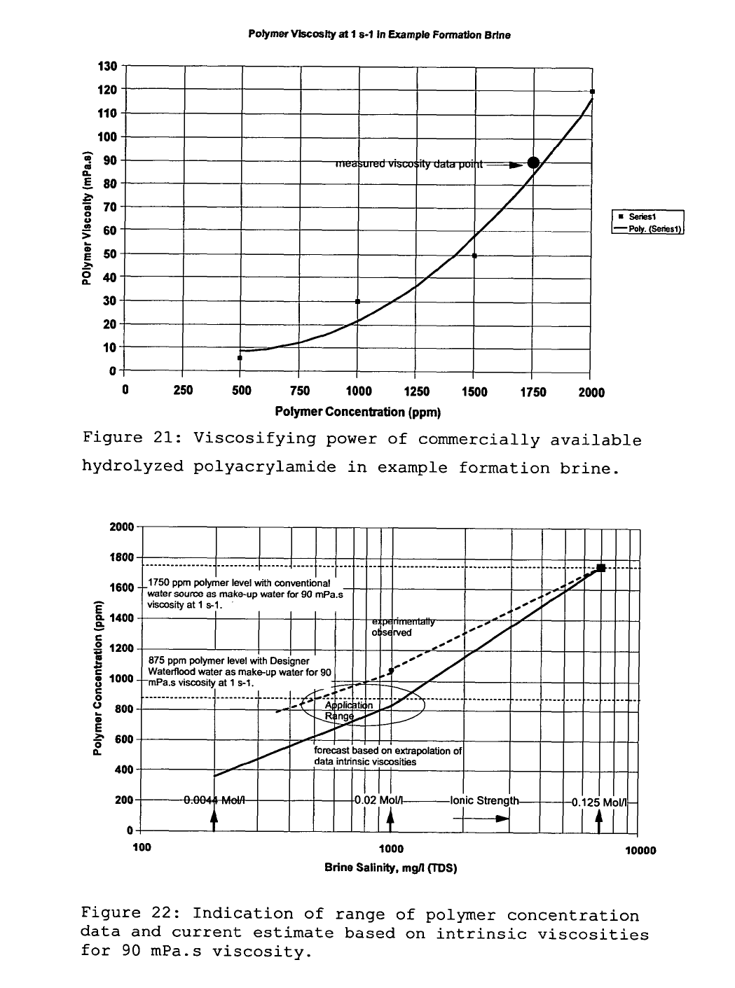

FIG. 18 shows the observed temporary drop in water cut around 2003, which coincides with breakthrough of the fresh water. The history match of the development of the water cut was much improved upon the assumption that the fresh water injection reduced the fractional flow. In FIG. 19 shows the observed oil production rate, including the occurrence of a small bank, which coincides with the temporary drop in water cut. The simulated history match of the oil production rate is clearly improved, if a reduction in fraction flow caused by the fresh water injection is assumed. It is estimated that the amount of produced oil has increased by 4-5% due to the fresh water injection, with only half of the layers flooded. The temporary drop in watercut is believed to be the result of an oil bank in front of the fresh water slug, as a result of improved displacement efficiency by wettability modification towards more waterwet state (FIG. 18, onset). This interpretation is supported by the results from the laboratory tests on Middle Eastern core samples described before, which are representative for this particular reservoir.

From the foregoing detailed description of various embodiments of the method according to the invention the following conclusions may be drawn:
1. In-house experimental work demonstrates that Fresh Water Flooding in mixedwet/oilwet sandstones may cause wettability modification towards increased waterwet state. In absence of an efficient water/oil gravity drainage process, application on reservoir scale may yield increased displacement sweep efficiency by several percent.
2. Application of Fresh Water Flooding seems possible at salinity levels outside the region of formation damage, where adsorbed hydrocarbons are expelled from clay particles but the clays remain intact.
3. Addition of low concentration polymer might be useful for flood stabilization and compensation for some possible loss on the volumetric sweep efficiency.
4. In-house experimental work indicates that cation exchange processes as a result of Fresh Water Flooding may be partly responsible for wettability modification towards increased waterwetness. However, the major contribution to such wettability modification comes from sufficient reduction in brine ionic strength. Therefore, we currently believe that the mechanism of Fresh Water Flooding primarily relies on expansion of electrical double layers and to lesser extent on cation exchange processes.
5. Fresh Water Flooding design can probably be based on brine characterization via solution Ionic Strength.
6. Probably, the distribution over the rock surface (grain coating) rather than the bulk amount of clay determines whether Fresh Water Flooding can be usefully applied in a particular sandstone reservoir.
7. Fresh Water Flooding puts specific requirements to sandstone reservoirs with respect to initial wettability and clay mineralogy, e.g. there should be no abundancy of smectite and chlorite clays. Hence, not all fields apply.
8. The presence of calcium in formation water is a major factor that causes reservoirs to become more oilwet. Therefore, seawater injection into the oil legs of reservoirs with rather fresh formation water may make these reservoirs more oilwet. This in turn may suppress oil production.
9. In carbonate reservoirs, wettability modification by manipulation of brine ionic composition is possible by anion exchange processes and has been well-established for chalk material. In-house experimental work indicates that the process may also work for microcrystalline limestone material, as found in the Middle East.

The aqueous displacement fluid used in the method according to the invention may comprise a viscosifying polymer and on the basis of the following EXAMPLES 1 and 2 it is explained that in particular Polymer Flooding with relatively high polymer concentrations, for example at least 200 ppm (mass), will improve mobility control by viscosification of the injection water phase to viscosity levels above 1 mPa·s.

This results in two benefits:
1. Improved Oil Production by Wettability Modification as a result of the use of the aqueous displacement fluid according to the invention as make-up water, compared to Polymer Flooding with a conventional water source as make-up water, according to the same principles as outlined before.
2. Reduction in mass amount of polymer (kg) required up to about a factor 2, if the make-up water of the Polymer fluid has an Ionic Strength below 0.15 Mol/l, preferably below 0.1 Mol/l, compared to a Polymer Flood which is based on a conventional water source as make-up water.

These benefits will be further explained on the basis of the following EXAMPLES 1 and 2.

### Example 1

In this example the following equations (1)-(5) on polymer viscosifying power are used.

The intrinsic viscosity (m³/kg) that characterizes a particular polymer solution is defined as:

$$[ {η}_{o} ] = \frac{η ( c ) - {μ}_{w}}{c \cdot {μ}_{w}} \qquad ( 1 )$$

(in the limit of zero shear-rate and polymer concentration c, in kg/m³).

Here, η(c) denotes the polymer viscosity at polymer concentration c and

$${μ}_{w} = {lim}_{c -> 0} η ( c ) ,$$

being the viscosity of the brine, in which the polymer is dissolved.

In accordance with the teachings of the handbook “Viscosity of Polymer Solutions” written by M. Bohdaneky and J. Kovar, published in 1982 by Elsevier Scientific Publishing, the viscosity of a polymer solution at low shear can be written as:

η(c)=μ_{w}·(1+[ηₒ]c+k₁·[ηₒ]²c²+k₂·[ηₒ]³c³+. . . ) (2)

Here k₁ and k₂ are constants.
The term k₁ is called: Huggins coefficient.
A typical range for the Huggins coefficient is between 0.4 and 1.22-2.26 (page 177 of the above-mentioned handbook “Viscosity of Polymer Solutions”).

It thus follows that at low shear, the enhancement in viscosity that can be achieved by polymer addition is governed by the product c·[ηₒ].

From a series of measurements on polyacrylamides at 25° C., the intrinsic viscosity is given by:

$$[ {η}_{o} ] = {[ {η}_{o} ]}^{*} \cdot {[ 1.0 + \frac{{p}^{*} \cdot Z}{{( M \cdot {[ {η}_{o} ]}^{*} \cdot I )}^{1 / 2}} ]}^{3. / 2} \qquad ( 3 )$$

with:
p*=0.027
I denotes the solution ionic strength (contribution of both brine and polymer), in kmol/m³. [ηₒ]* is the intrinsic viscosity in absence of charge effects (Z=0) and given by:

[ηₒ]*=1.34·10⁻⁵·M^{0.713} (4)

M denotes polymer molecular weight and Z the number of elementary electrical charges along the polymer chain.
Z is given by:

$$Z = \frac{δ \cdot α \cdot M}{( 1 - α ) \cdot 71 + α \cdot 94} \qquad ( 5 )$$

Here δ denotes the degree of ionization and α denotes the degree of hydrolysis.
Experimental work was done at pH=8, where we may assume full ionization (δ=1).
The dependence of intrinsic viscosity on brine ionic strength for various polymers with M and degree of hydrolysis is shown in FIG. 20.

Calibration to in-house experiments was done as follows.

Using a commercially hydrolyzed polyacrylamide, which is characterized by molecular weight M=18×10⁶−20×10⁶ and degree of hydrolysis 25%, at 50° C., the following two polymer viscosities were measured:

| | | | | Total | Polymer |
|---|---|---|---|---|---|
| Brine | Brine | Polymer | Polymer | solution | viscosity |
| salinity | Ionic | concen- | Ionic | ionic | at shear |
| (mg/l | Strength I | tration | Strength I | strength | rate 8 s⁻¹ |
| TDS) | (kmol/m³) | (ppm) | (kmol/m³) | (kmol/m3) | (mPa · s) |
| 25500 | 0.4 | 725 | 0.002362 | 0.402 | 3.5 |
| 255 | 0.004 | 100 | 0.000326 | 0.0043 | 3.5 |

These data are described as follows:
μ_{w}(255 mg/l TDS and 50° C.)=0.6 mPa·s
μ_{w}(25500 mg/l TDS and 50° C.)=0.6×1.05=0.63 mPa·s≅0.6 mPa·s.

If it is assumed that the other parameters in the viscosity description are more or less temperature-independent in at least the range 25-50° C.

For this particular polymer we then have:

→[ηₒ]*=1.34·10⁻⁵·(18·10⁶)^{0.713}=2.0 m³/kg Eq. (4)

→Z=5.86×10⁴ Eq. (5)

For polymer in brine of salinity 25500 mg/g TDS (0.4 kmol/m³):

→[ηₒ]=3.36 m³/kg Eq. (3)

For polymer in brine of salinity 255 mg/g TDS (0.004 kmol/m³):

→[ηₒ]=23.5 m³/kg Eq. (3)

Considering Eq. (2) this implies that to achieve the same polymer viscosity the polymer concentrations cₚ need to satisfy:

cₚ(25500 mg/l)·3.36=cₚ(255 mg/l)·23.5,

which implies:

$$\frac{{c}_{p} ( 25500 mg / l )}{{c}_{p} ( 255 mg / l )} = \frac{23.5}{3.36} = 7$$

The ratio 7 corresponds well with the factor 7.25 actually found.

### Example 2

### Application Example

The composition of an example formation brine is shown in Table 6.

It is characterized by overall salinity level of 7878 mg/l and ionic strength I of about 0.133 kmol/m³ (taking the major elements into account). The brine pH is 7.9, hence full ionization may be assumed (δ=1).

There is a rather significant Ca²⁺ level of 100 mg/l, indicating that the example reservoir wettability may significantly deviate from purely waterwet state and that there may be scope for IOR by wettability modification to more waterwet state, using the method according to the invention.

The polymer viscosity in the example formation brine at low shear rate 1 s⁻¹ is shown in FIG. 22.

The polymer type chosen is a commercially available hydrolyzed polyacrylamide with molecular weight between 18×10⁶ and 20×10⁶ and degree of hydrolysis about 25%. It is experimentally determined that about 1750 ppm of this polymer dissolved in the example formation brine at 51° C. (example formation temperature) at low shear rate 1 s⁻¹ will yield a solution viscosity of 90 mPa·s.

The following experimental viscosity data point was obtained in about the same temperature range in water of about 1000 ppm TDS salinity level: at 1 s⁻¹ and 1000 ppm TDS the required polymer concentration to yield a viscosity level of 90 mPa·s is 1050 ppm.

The experimentally obtained data points are summarized below.

| Brine | | Polymer concentration |
|---|---|---|
| salinity | Ionic | (ppm mass), required to |
| (mg/l | Strength | yield 90 mPa · s |
| TDS) | (Mol/l) | viscosity level at 1 s⁻¹ |
| 1000 | 0.0197 | 1050 |
| 7000 | 0.125 | 1750 |

The reduction in mass amount of polymer that would be required to obtain the same viscosity level of 90 mPa·s when using brines of lower salinity level is identified as follows, using two iteration steps I and II.

The following brines are considered at the example reservoir temperature 50° C.:
μ_{w}(200 mg/l TDS and 50° C.)=0.6 mPa·s
μ_{w}(1000 mg/l TDS and 50° C.)=0.6×1.002≅0.6 mPa·s.
μ_{w}(7000 mg/l TDS and 50° C.)=0.6×1.015≅0.6 mPa·s.
   Similarly as before intrinsic viscosities can be calculated using iteration steps I and II:
   I) First iteration step:
   Ignore contribution of polymer to ionic strength:

| Brine | | |
|---|---|---|
| salinity | Brine Ionic | Intrinsic |
| (mg/l | Strength I | Viscosity |
| TDS) | (kmol/m³)*⁾ | (m³/kg) |
| 200 | 0.0034 | 25.8 |
| 1000 | 0.0171 | 10.5 |
| 7000 | 0.1198 | 4.7 |

*⁾Approximation: it consists of pure NaCl only.

To achieve the same viscosity level we thus have:

cₚ(200mg/l TDS)·25.8=cₚ(1000 mg/l TDS)·10.5=cₚ(7000 mg/l TDS)·4.7

which implies:

$$\frac{{c}_{p} ( 7000 mg / l )}{{c}_{p} ( 1000 mg / l )} = \frac{10.5}{4.7} = 2.2 and$$

$$\frac{{c}_{p} ( 1000 mg / l )}{{c}_{p} ( 200 mg / l )} = \frac{25.8}{10.5} = 2.5$$

This means: if cₚ(7000 mg/l)=1750 ppm, cₚ(1000 mg/l)=795 ppm and cₚ(200 mg/l)=318 ppm.
II) Second iteration step:
Include contribution of polymer to overall ionic strength:

| | | Polymer | | | |
|---|---|---|---|---|---|
| | | concen- | | Total | |
| Brine | Brine | tration | Polymer | solution | |
| salinity | Ionic | (ppm) | Ionic | ionic | Intrinsic |
| (mg/l | Strength I | from 1^{st} | Strength I | strength | Viscosity |
| TDS) | (kmol/m³) | iteration | (kmol/m³) | (kmol/m³) | (m³/kg) |
| 200 | 0.0034 | 318 | 0.001035 | 0.004458 | 22.0 |
| 1000 | 0.0171 | 795 | 0.002590 | 0.0197 | 9.76 |
| 7000 | 0.1198 | 1750 | 0.005700 | 0.1254 | 4.60 |

To achieve the same viscosity level we thus have:

cₚ(200mg/l TDS)×22.0=cₚ(1000 mg/l TDS)×9.76=cₚ(7000 mg/l TDS)×4.60

which implies:

$$\frac{{c}_{p} ( 7000 mg / l )}{{c}_{p} ( 1000 mg / l )} = \frac{9.76}{4.60} = 2.12 and$$

$$\frac{{c}_{p} ( 1000 mg / l )}{{c}_{p} ( 200 mg / l )} = \frac{22.0}{9.76} = 2.25$$

This means: if cₚ(7000 mg/l)=1750 ppm, cₚ(1000 mg/l)=825 ppm and cₚ(200 mg/l)=365 ppm.

These results, as well as the experimentally observed data points (1050 ppm mass polymer at 1000 ppm TDS brine and 1750 ppm mass polymer at 7000 ppm TDS brine, both yielding viscosity levels of 90 mPa·s at 1 s⁻¹ at around 50° C.), are shown in FIG. 22.

1. A method for enhancing recovery of crude oil from a porous subterranean formation of which the pore spaces contain crude oil and connate water, the method comprising:
determining the ionic strength of the connate water; and
injecting an aqueous displacement fluid having a lower ionic strength than the ionic strength of the connate water into the formation,
where the ionic strength of the aqueous displacement fluid is below 0.15 Mol/l.

2. The method of claim 1, wherein the ionic strength of the aqueous displacement fluid is below 0.1 Mol/l.

3. The method of claim 1, wherein the method further comprises:
determining the molar concentration of multivalent cations in the connate water; and
injecting an aqueous displacement fluid having a lower molar concentration of multivalent cations than the connate water.

4. The method of claim 1, wherein the aqueous displacement fluid comprises a surfactant, a foaming agent or an Enhanced Oil Recovery(EOR) compound.

5. The method of claim 1, wherein the aqueous displacement fluid comprises steam, water, or a mixture thereof obtained from an aquifer, river, lake, sea or ocean.

6. The method of claim 1, wherein the formation is a mineral-bearing sandstone formation.

7. The method of claim 1, wherein the formation is a carbonate formation.

8. The method of claim 1, wherein the aqueous displacement fluid comprises a viscosifying polymer.

9. The method of claim 8, wherein the aqueous displacement fluid has a viscosity level above 1 mPa·s and comprises at least 200 ppm (mass) of viscosifying polymer.

10. The method of claim 9, wherein the viscosifying polymer comprises a hydrolyzed polyacrylamide.
